(19) United States
(12) Patent Application Publication
(10) Pub. No.: US 2004/0051260 A1
(43) Pub. Date: Mar. 18, 2004

(54) Lifting and leveling apparatus and method

(75) Inventor: Thomas N. Oldiges, Bellefontaine, OH (US)

Correspondence Address: Law Office of Barbara Joan Haushalter, 228 Bent Pines Court, Bellefontaine, OH, 43311, US

(73) Assignee: AXIS CORP

(21) Appl. No.: 10/395,600

(22) Filed: Mar. 24, 2003

Related U.S. Application Data
(63) Continuation-in-part of application No. 09/829,165, filed on Apr. 9, 2001, now abandoned.

(51) Int. Cl. B60G 17/005

(52) U.S. Cl. 280/5.507

(57) ABSTRACT

A lifting and leveling apparatus and method improves the handling and transportation of a burial vault and monument. A lift mechanism is attached by pivot pins to both the transport (lower) portion of the structure and the vault handling (upper) portion of the structure, thereby allowing the vault or monument to be lifted on a straight vertical axis or to be tilted side to side to balance the load, while the entire load and equipment remains on the transport tires. The deck, carrying the vault or monument and lid, and comprising the frame structure for positioning the vault or monument and the lift mechanism, can lift and pivot independent of the transport vehicle to adjust the center of gravity of the deck and maintain the load in a level orientation, while in the transport mode and while stationary. The lift/tilt mechanism is located so as to adjust the center of gravity of the deck independent of the transport vehicle.

### RELATED APPLICATIONS

This application is a continuation-in-part of copending application Ser. No. 09/829,165, filed Apr. 9, 2001, now abandoned.

### TECHNICAL FIELD

The present invention relates to burial vault transportation and, more particularly, to a lifting and leveling device for transporting, handling and positioning a burial vault.

### BACKGROUND ART

Burial vaults for transportation to, and use at, a grave site often weigh more than two thousand pounds. The great weight of the burial vault creates problems with the transporting and positioning of the vault. Motorized or self-propelled carrier vehicles are known and used to transport and position the heavy vault.

A further challenge is realized by the arrangement of the monuments in most cemeteries and the often rolling grounds of a cemetery. Most cemeteries are located on hilly land, traditionally unsuitable for farming or developing. Not only must the carrier vehicle be able to fit between existing grave stones, typically a distance of just a few feet, but it must also be able to maintain the load distribution of the vault as it moves across the slopes and up and down the hilly terrain of the cemetery. When traversing a hill or other uneven ground condition in a cemetery, the probability of the equipment rolling over on its side increases with the degree of incline.

The limited distance between the grave stones necessitates a narrow vehicle, while the size and handling requirements of the burial vault necessitates a tall vehicle. The propensity to tip, therefore, is exacerbated by the high center of gravity of the overall structure, in relation to the narrow width of the overall structure. This narrow, tall, heavily weighted vehicle then, is required to navigate the sloping terrain of the cemetery, making a possible rollover a continuous concern.

Even after delivery to the proper grave site at the cemetery, an additional problem is still encountered. The extreme weight of the burial vault coupled with the depth of the hole in which it is to be positioned, makes it difficult to properly position the vault in the grave. This difficulty is increased when the vehicle holding the burial vault is situated on an incline.

It is seen then that there is a need for an improved technique for maintaining a level, balanced load on the transport vehicle, to enhance the transporting, lifting and positioning of the burial vault, regardless of the terrain on which the vehicle is traveling or at rest.

### SUMMARY OF THE INVENTION

This need is met by the leveling technique according to the present invention, wherein the vault, the overall frame for lifting and positioning the vault/load, and the lift mechanism can be leveled side to side, independent of the self-propelled trailer and drive mechanism. The lift mechanism is attached by pivot pins to both the transport (lower) portion of the structure and the vault handling (upper) portion of the structure, thereby allowing the vault or monument to be lifted on a straight vertical axis or to be tilted side to side to balance the load, while the entire load and equipment remains on the transport tires.

In accordance with one embodiment of the present invention, the operation and safety of handling of burial vaults and monuments in cemeteries is significantly improved. The deck, carrying the vault or monument and lid, and comprising the frame structure for positioning the vault or monument, and the lift mechanism, can lift and pivot independent of the transport vehicle, to adjust the center of gravity of the deck, while in the transport mode and while stationary. The lift/tilt mechanism is located so as to adjust the center of gravity of the deck independent of the transport vehicle.

Other objects and advantages of the invention will be apparent from the following description, the accompanying drawing and the appended claims.

### BRIEF DESCRIPTION OF THE DRAWING

FIG. 1 shows a typical transport vehicle, carrying a burial vault and associated mechanisms;

FIG. 2 is a prior art view of the transport vehicle of FIG. 1, traversing an incline;

FIG. 3 is a view of the transport vehicle of FIG. 1, traversing the incline as in FIG. 2, but applying the tilt mechanism of the present invention to level the burial vault and associated mechanisms;

FIG. 4 is an illustration of a prior art technique for leveling a vault load on an uneven turf;

FIG. 5A is a side view of the vault handler shown in a transport mode;

FIG. 5B is a side view of the vault handler shown with the vault handling portion in a raised position; and

FIG. 6 illustrates the lift and tilt mechanism in accordance with the present invention, to achieve the tilt feature illustrated in FIG. 3 and the lift feature illustrated in FIG. 5B.

### DETAILED DESCRIPTION OF THE INVENTION

Since most cemeteries are located on hilly land, unsuitable for farming, there are distinct problems inherent in the handling of concrete burial vaults and monuments. The transporting equipment must be narrow enough to drive between existing graves and monuments, yet tall enough to handle large and heavy loads. Hence, the possibility of a rollover always exists. The lifting and tilting capabilities of the present invention can be accomplished without the use of mechanical lifting devices that extend down from the frame, in direct contact with the turf. That is, the equipment can remain on the tires, with the tires being the contact point with the ground. Furthermore, leveling can be accomplished simultaneously while traversing the hilly conditions in a cemetery.

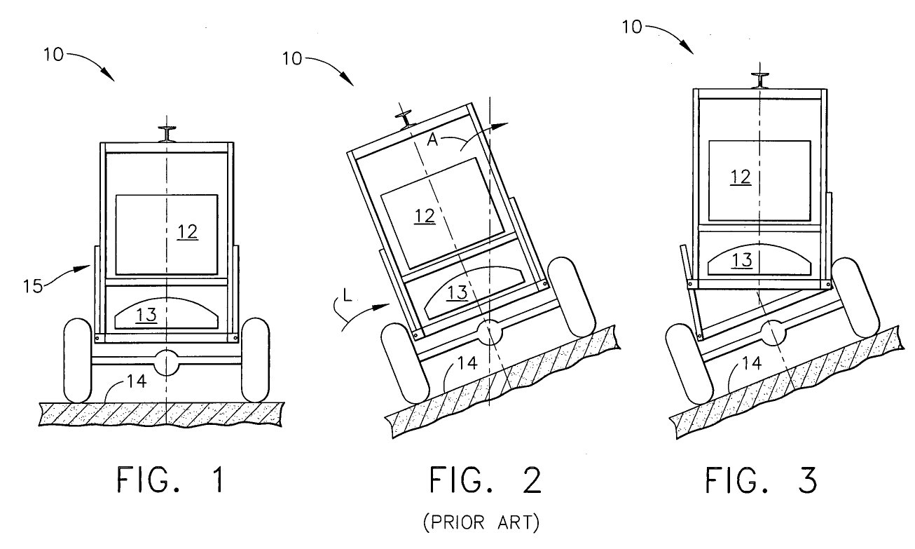

Referring now to the drawings, there is illustrated in FIG. 1 a typical transport vehicle 10, carrying a burial vault 12 and a vault lid 13. The vault 12 and lid 13 are transported in a load-carrying portion or deck 15 of the vehicle 10. The layout of a typical cemetery and the load requirements for transporting the vault 12 and lid 13 dictate that the vehicle 10 be both narrow and tall. When ground surface 14 is level, the vehicle can manage the load 12, 13 without tipping. However, when the ground surface 14 is inclined, as shown in FIG. 2, the consequent shift of the center of gravity of the load causes the load 12, 13 to lean precariously, with the possibility of a rollover increasingly a concern.

The present invention corrects for the problem illustrated in FIG. 2 by applying a tilt capability to adjust the center of gravity of the burial vault 12, lid 13, and associated mechanisms, as illustrated in FIG. 3. The tilt feature engaged in FIG. 3 redirects the center of gravity of the load-carrying portion 15 of the vehicle 10 as the surface 14 changes, to help prevent rollover when traversing an inclined surface. The leaning side, for example side L in FIG. 2, is pivoted upward as shown in FIG. 3 to shift the centerline of the load-carrying portion 15 to the right in the direction of arrow A, thereby shifting the center of gravity to continuously level the load simultaneously with the vehicle traversing the hilly terrain.

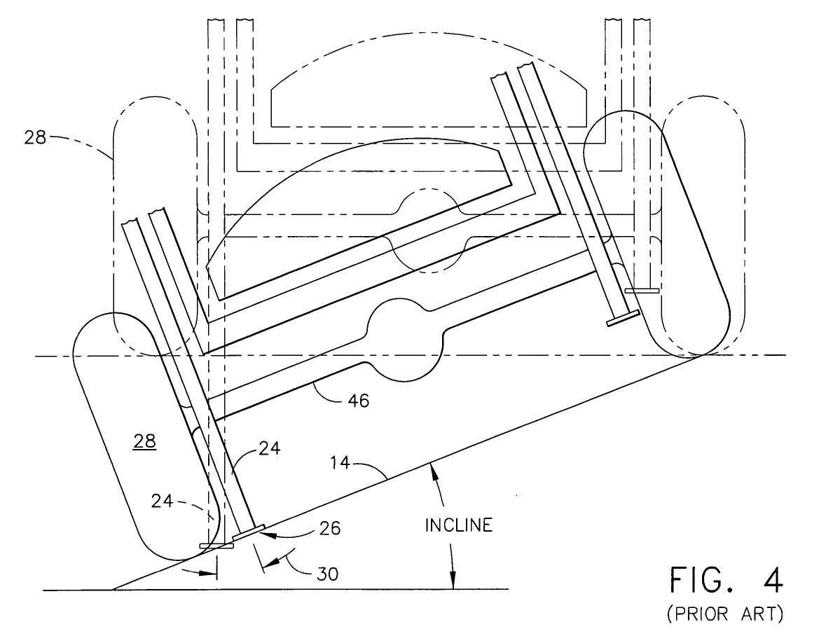

The precarious structure of vault handling vehicles has long been recognized as a problem. The operator of the vehicle attempts to control the load during transport, by adjusting vehicle speed or direction of travel. However, when the vault handling vehicle has arrived at a grave site, and the vehicle must rest on an inclined surface at the site, the industry has tried to address the problem of properly lowering the vault 12 and lid 13 into the grave. The problem of managing to accurately position the vault above the grave so as to lower the vault into the site when the vault is tilted, has long been known in the industry. FIG. 4 illustrates the prior art method of addressing this problem. In the prior art, the low side of the vehicle is actually lifted in its entirety, to center the load. A lift bar 24 is positioned on the ground 14 at location 26, and the entire low side of the vehicle, including the low side tire 28 is raised until the load 12, 13 is level. Unfortunately, the lift bar 24 pivots on the turf, in the direction of arrow 30, causing damage to the turf. Such damage to cemetery turf adversely affects the serenity and landscape artistry that is desirable in a cemetery setting. Furthermore, such an arrangement cannot be utilized when the vehicle is moving.

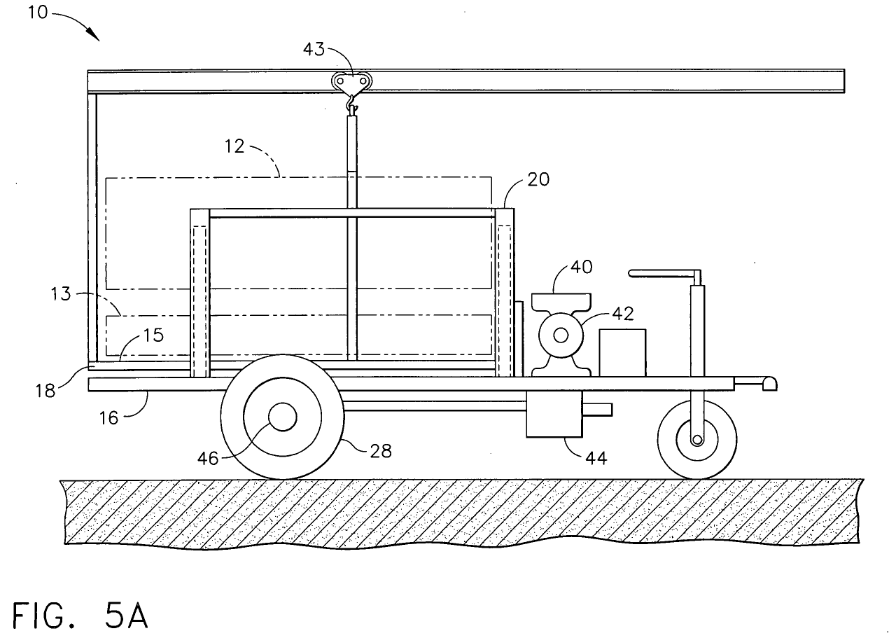

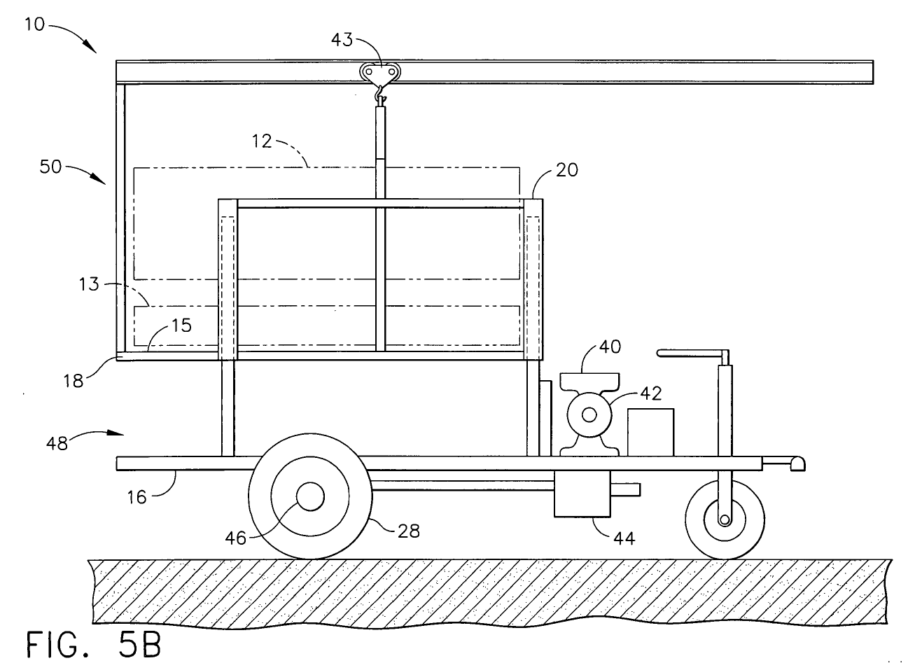

The present invention avoids this damage to the turf as well as the problem of load leveling during transport, by lifting and tilting only the vault handling portion of the equipment, allowing the tires to remain on the ground. As can be seen in FIGS. 5A and 5B, the vehicle 10 can adjust the load 12, 13, vertically. The load can also be shifted side to side, as the terrain requires, to maintain the load horizontally level. The vertical and side to side load adjustments can occur while the vehicle is moving, as the adjustments do not rely on any additional ground contact aside from the tires 30. In addition, if the vehicle must unload on an incline, the lifting and tilting mechanism of the present invention does not dig into or pivot the landscape, as it is only the tires 30 that contact the ground surface 14.

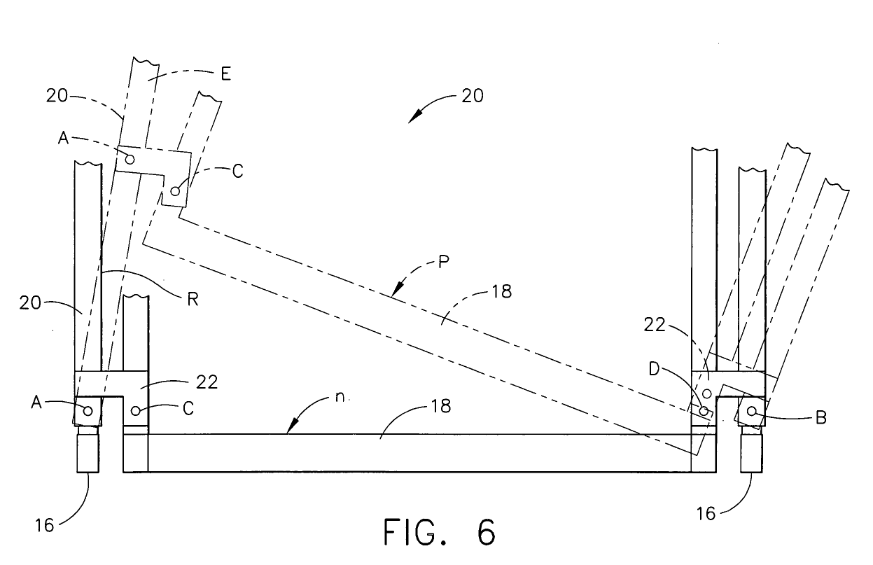

The improved lifting and leveling apparatus of the present invention transports and positions the burial vault or monument load 12, 13, responsive to the terrain conditions. The self-propelled mobile burial vault and monument load handling vehicle 10 with its deck 15 and frame means 16 to support the load, uses the lift/tilt mechanism 20 to move either or both sides of the load up or down to continuously maintain the load in a balanced orientation responsive to the varying terrain traversed by the load vehicle. A first pivot means A, B in FIG. 6, attaches the lift mechanism 20 to the lower transport portion 48 of vehicle 10, while a second pivot means C, D in FIG. 6, attaches the lift mechanism 20 to the upper vault handling portion 50 of vehicle I0. The first and second pivot means, best illustrated in FIG. 6, allow the load to be lifted along a vertical axis as shown in FIG. SB, or to be tilted side to side as shown in FIG. 3, to maintain the load in a balanced orientation, independent of the vehicle tire angle or orientation.

Continuing with FIGS. 5A, 5B, and 6, there is illustrated in FIG. 6 the lift and tilt capability in accordance with the present invention. Equipment frame 16 typically carries the mechanisms necessary to achieve mechanical transport of the vehicle, such as an engine 40, a pump 42, a transmission 44, and an axle 46. It is a particularly advantageous feature of the present invention that the frame 16, with all of its associated equipment, does not lift or tilt as the center of gravity is adjusted for the load. Only the load platform 18, deck 15, and the load 12, 13 realign to maintain level positioning. Instead, a cable driven trolley 43 enables the operator of the vehicle to control the transverse motion of the vault in varying terrain conditions. The load is adjusted in accordance with operation of the cable driven trolley, responsive to the varying terrain conditions recognized by the vehicle operator.

Continuing with FIGS. 5A, SB and 6, the cable driven trolley allows load platform 18 to be shifted upward on either side, or to be moved up and down in its entirety as in FIGS. 5A and 5B, maintaining the platform in horizontal alignment. In FIG. 6, the lift/tilt mechanism 20, with its associated cable driven trolley 43, is shown in a retracted position, R, and an extended position indicated by dotted lines E. Pivot points A and B remain perpendicular to the vertical frame of the lift mechanism 20, while pivot points C and D necessarily adjust perpendicularity with respect to the lift/tilt mechanism 20 as the platform 18 moves. As the vehicle 10 traverses varying terrain, such as an incline as in FIG. 3, the vehicle operator can simultaneously direct the vehicle over the varying terrain and readjust the center of gravity of the load platform 18 to balance the load. When traversing an incline as in FIG. 3, the load platform 18 can be raised on the left side, as shown in FIGS. 3 and 6, by operation of the cable driven trolley, moving from its normal position N to a pivoted position P. As the load platform rises, the lift/tilt mechanism 20 will move from its retracted position R to an extended position E. Pivot element 22 moves with the load platform 18 and the lift/tilt mechanism 20, although pivot points A and B do not move linearly along the lift/tilt mechanism 20.

The present invention as illustrated in FIGS. 3 and 6, with the left side of the load lifting to compensate for the incline, is shown for exemplary purposes only. It will be obvious to those skilled in the art that the tilting feature is equally applicable on either side of the load, depending on the incline encountered. Furthermore, the load platform, or deck, can be moved straight up and down, such as is illustrated by comparing FIGS. 5A and 5B, responsive to the terrain and the desired positioning of the load.

As can be seen in FIGS. 3, 5A, 5B and 6, the lift/tilt capability of the present invention will allow the operator to continuously realign the center of gravity of the load as the transport vehicle 10 traverses the cemetery grounds. Once the vehicle 10 reaches its destination, the lift/tilt capability can still be engaged to facilitate moving of the burial vault 12 and subsequently the lid 13 off of the vehicle 10 and into the grave site. For example, if the transport vehicle is necessarily parked on an incline, due to the space constraints of the cemetery as well as the natural contours of the cemetery grounds, it can be difficult to properly align the vault with the site. The lift and tile mechanism of the present invention solves for the inherent difficulties and long-standing problems unique in this industry.

It will be obvious to those skilled in the art that the means to move the load platform and associated elements can be any of a variety of suitable means. For example, the lifting and tilting can be achieved using electrical means, hydraulic means, a crank mechanism, or other mechanical means, without departing from the scope of the invention as described and claimed herein.

The invention has been described in detail with particular reference to certain preferred embodiments thereof, but it will be understood that modifications and variations can be effected within the spirit and scope of the invention.

What is claimed is:

1. For a self-propelled vehicle used to transport and position a burial vault or monument load, a method for maintaining the burial vault or monument load in balance during transport over varying terrain, the method comprising the steps of:
providing a deck associated with the self-propelled vehicle for carrying the burial vault or monument load, the deck comprising a frame to support the load and a load platform to receive the load; and
using a cable driven trolley to move the load platform up or down on either or both sides to continuously maintain the load in a balanced orientation responsive to varying terrain traversed by the self-propelled vehicle.

2. A method as claimed in claim 1 wherein the load platform is attached to the frame at a plurality of pivot points.

3. A method as claimed in claim 2 wherein the plurality of pivot points allow the load to be adjusted along a vertical axis or to be tilted side to side to maintain the load in a balanced orientation.

4. For a self-propelled vehicle used to transport and position a burial vault or monument load, a lift and tilt mechanism for maintaining the burial vault or monument load in balance during transport over varying terrain, comprising:
a deck associated with the self-propelled vehicle for carrying the burial vault or monument load, the deck comprising a frame to support the load and a load platform to receive the load; and
a cable driven trolley for moving the load platform up or down on either or both sides to continuously maintain the load in a balanced orientation responsive to varying terrain traversed by the self-propelled vehicle.

5. A mechanism as claimed in claim 4 wherein the load platform is attached to the frame at a plurality of pivot points.

6. A mechanism as claimed in claim 5 wherein the plurality of pivot points allow the load to be adjusted along a vertical axis or to be tilted side to side to maintain the load in a balanced orientation.
